(19) United States
(12) Patent Application Publication
(10) Pub. No.: US 2008/0205838 A1
(43) Pub. Date: Aug. 28, 2008

(54) Optical Device Including a Buried Grating With Air Filled Voids and Method For Realising It

(76) Inventors: Davide Diego Crippa, Milano (IT); Melissa Di Muri, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/632,162

(22) PCT Filed: Nov. 17, 2004
(86) PCT No.: PCT/EP2004/013028

§ 371 Date: Dec. 17, 2007

(30) Foreign Application Priority Data
Jul. 22, 2004 (EP) PCT/EP2004/008200

(51) Int. Cl. G06K 9/00; G02B 6/124; G02B 6/132; G02B 6/293

(52) U.S. Cl. 385/126

(57) ABSTRACT

An optical device includes a waveguide, the waveguide having a core surrounded by a cladding, the cladding including a lower cladding, the core being placed above the lower cladding, a lateral cladding adjacent to a first and a second opposite lateral sides of the core, and an over-cladding, the over-cladding being positioned above the core and lateral cladding. The core and lateral cladding define a guiding layer. A grating structure is formed in the guiding layer, which includes a plurality of empty trenches. The over-cladding includes a cap layer, the cap layer having a first refractive index and being in contact with the grating structure. The first refractive index of the cap layer is substantially identical to the refractive index of the lateral cladding in contact with the cap layer. Additionally, the cap layer is located above the trenches and forms bridges connecting each couple of adjacent trenches of the plurality, so that voids are formed in the trenches.

### TECHNICAL FIELD

The present invention relates to an optical device comprising a grating, in particular gratings including a plurality of trenches buried in the waveguide.

Additionally, the present invention is directed to a method to realize an optical device including a grating.

### TECHNOLOGICAL BACKGROUND

Wavelength division multiplexed (WDM) or dense WDM (DWDM) optical communication systems, require the ability to passively multiplex and demultiplex channels at certain network nodes and, in some architecture, to add and drop channels at selected points in the network, while allowing the majority of the channels to pass undisturbed.

Diffraction gratings, for example Bragg gratings, are used to separate the independent optical channels, which have different transmission wavelengths and are transmitted along a line, by reflecting one wavelength into a separate optical path, while allowing all other wavelengths to continue onward through the original line.

In particular, gratings are used to isolate a narrow band of wavelengths, thus making possible to construct a device for use in adding or dropping a light signal at a predetermined centre wavelength to or from a fiber transmission system. This centre wavelength is known as Bragg wavelength λ_{B}. The Bragg wavelength is related to the effective index n_{eff} of the waveguide in which the grating is realized and to the grating period Λ(z) (both typically being function of the coordinate z along the waveguide axis) by the following Bragg phase matching condition:

λ_{B}=2n_{eff}Λ(z).

Therefore, by selectively reflecting a predetermined wavelength band, an optical Bragg diffraction grating may be interposed in an optical transmission line to filter a multi-wavelength optical signal.

Gratings can be realized, among other methods, by etching a corrugation into a waveguide. As an example, a plurality of trenches can be realized on the waveguide, either on its core or in the cladding, selecting a duty cycle, a depth and other physical dimensions according to the device's desired optical characteristics. The trenches may be formed by an etching process, however any other suitable technique may be employed as well.

These trenches can be afterwards either filled with a suitable solid or liquid material, or left empty, i.e. filled with air, other gases or left under vacuum. The type of trenches' filler depends on the desired grating characteristics. For example, if the trenches are filled with air (n=1), the resulting refractive index contrast in the grating along the propagating direction is higher than with any other grating filler.

In the field of semiconductor device, it is known to form air gaps covered by a film between separated electrical conductors to reduce capacitive coupling therebetween. As an example, European patent application n. 1152463 in the name of Tokyo Electron Limited describes a semiconductor device comprising a wiring layer including a plurality of wirings and concave portions being defined between wirings and an insulating film, wherein the insulating film is adapted to define depleted regions within the concave portions while inhibiting itself from filling the concave portions in the wiring layer. The insulating films include SiO₂ films, having a dielectric constant equal to 4, SIOF films having a dielectric constant of 3.5 and fluorinated carbon films having a further smaller dielectric constant.

Additionally, U.S. patent application No. 2003/0168747 shows a method to realize an air gap intermetal layer dielectric by utilizing a dielectric material to bridge underlying metal lines. A first and second electric conductors are realized on a substrate and a gap is formed between them. A gap bridging dielectric material is formed and extends from over said first electrical conductor to over said second electrical conductor by way of above the gap. The dielectric material comprises a spin-on-polymer.

The following patents describe methods of forming a cladding layer by plasma deposition.

In U.S. Pat. No. 5,571,576 in the name of Watkins-Johnson, a method for producing a fluorinated silicon oxide dielectric layer by plasma chemical vapour deposition is shown. The fluorinated layer formed has a dielectric constant which is less than that of a silicon oxide layer. The characteristics of the so formed layer are a good gap fill, isolation, stress and step coverage properties on patterned material layers. In particular, the gap fill properties are so excellent that etching of the substrate on which this layer is deposited and deposition of the fluorinated silicon dioxide layer occur simultaneously.

U.S. patent application No. 2003/0113085 describes a method to realize an uppercladding layer over a waveguide core using a high-density plasma process. This layer is a silicate glass layer and it is deposited using the high-density plasma technique in order to mitigate the thermal strain by reducing the amount of material that requires thermal annealing. Indeed, this patent shows that using certain high density plasma processes to deposit the uppercladding layer, it is possible to avoid annealing, simplifying the process the process flow, reducing costs and improving homogeneity of the layer.

### SUMMARY OF THE INVENTION

The present invention relates to optical devices including grating structures, in particular grating structures which are buried in a waveguide. The waveguide considered in this application comprises a buried core, i.e. its core is surrounded by a cladding, and in particular it also includes a lower cladding on top of which the core is formed, a lateral cladding adjacent to two opposite lateral sides of the core and an over-cladding positioned above the core and the lateral cladding.

The over-cladding may comprise one or more layers, such as a cap layer, as it will be described below.

In the following, with the term “guiding layer”, the combination of the core and lateral cladding of the waveguide is defined. Therefore, when a structure is indicated to be formed in or on the guiding layer, it means that it can be formed either in the core of the waveguide, or in the lateral cladding of the same, or in both core and lateral cladding.

Additionally, the words “buried gratings” have in the following the meaning of embedded gratings, i.e. gratings which are in all directions surrounded by either the core or the cladding(s) of the waveguide, or by both of them.

These buried gratings can be realized in the guiding layer of the waveguide, i.e. in the core of the waveguide, and/or in the cladding of the same, depending on the desired optical characteristics of the device under issue. A grating realized on the core of the waveguide perturbs directly the travelling optical mode, while a grating realized only in the cladding of the waveguide perturbs the evanescent field of the propagating mode.

Additionally, the gratings hereby considered comprise a plurality of empty trenches, i.e. a plurality of subsequent gaps disposed in a given geometry. In the present context, with the term “empty trenches”, trenches filled with air, gases or left under vacuum are identified.

In order to realize such a device, after having obtained the plurality of trenches in the guiding layer by a suitable process (known per se), for example by an etching process, a layer of material, called in the following “cap layer”, is deposited over the trenches to bury the grating. Indeed, when a plurality of trenches is realized by etching on a wafer, generally each trench is surrounded by the waveguide forming material, and only the top portion of each trench is in contact with external air. These top portions are then to be covered in order to realize the buried grating.

Being the trenches empty, the material in which the cap layer is formed has not to fill the trenches themselves, but it has to cover them forming a substantially flat cap. This cap layer in other words comprises bridges between each couple of adjacent trenches connecting their respective tops, these bridges forming a uniform continuous layer.

Applicants have observed that even a very limited insertion of material within the trenches will cause a modification in the device optical response.

The cap layer exhibits poor gap filling properties which are obtained by properly selecting suitable parameters during the deposition process. In particular, Applicants have found that important parameters are the power and pressure in the deposition process of the cap layer, which can be selected in such a way that the material in which the cap layer is formed does not sink into the trenches.

Another main goal of the present invention is to realize low losses optical devices. For this purpose, the refractive index of the cap layer is substantially identical to the refractive index of the remaining cladding layer(s) of the waveguide which are in contact with the cap layer. Indeed, the travelling mode propagating in the waveguide is centred in the core if the refractive index difference between the core and the cladding(s) is the same in all directions perpendicular to the propagating direction. If there are several refractive index differences, the propagating mode is not any more centred in the core, but it shifts towards the region of larger index difference. The propagating losses in this latter case are higher than in the symmetric “centred” case.

This substantial identity between the refractive index of the cap layer and the refractive index of the cladding(s) in contact with the cap layer becomes especially important when the cap layer is directly in contact with the core of the waveguide, because any difference in the refractive index strongly perturbs the propagating mode.

In the present context, the words “substantially identical” indicate that the refractive index difference between the refractive index of the material in which the cap layer is realized and the refractive index of the material(s) in which the remaining cladding in contact with the cap layer is (are) realized is of the order of 10⁻⁴ or lower. A typical example is 3×10⁻⁴. If the remaining cladding of the waveguide (excluding the cap layer) in contact with the cap layer comprises different portions realized in different materials, this means that the refractive index difference between the refractive index of the cap layer and the refractive index of any material of all portions is of the order of 10⁻⁴.

Preferably, the cap layer comprises SiOₓ with 1≦×<2. A sub-stoichiometric silicon compound is preferred in order to obtain the desired refraction index of the cap layer as deposited, without the need of additional annealing phases, which are preferably avoided for the reasons that will become clearer in the following.

In a different preferred embodiment of the present invention, the cap layer comprises fluorinated silicon oxide, i.e., SiOₓF_{y}, with 1≦×<2 and 1≦y<2. Also in this case the compound is not stoichiometric in order to obtain the desired refractive index of the cap layer as deposited. The SiOₓ-based material used to form the cap layer can alternatively include carbon (C), nitrogen (N) or a combination thereof, or carbon and fluorine, i.e., SiON, SiOC, SiONC, or SiOCF compounds (for the sake of conciseness in notations, the subscripts indicating that these compounds are not stoichiometric are omitted). Organic Silicon Glass Oxide (SOG) can be alternatively selected as the cap layer material. Hereafter, with SiOₓ-based material it is meant either “pure” SiOₓ or compounds containing besides SiOₓ the above-mentioned elements (hereafter referred also to as dopants) or a combination thereof.

The dopant content in the cap layer is such that the desired refractive index is obtained, indeed varying the dopant content (where with the term “dopant” one or a combination of the above defined elements are indicated) the refractive index of the resulting layer changes.

In case of undoped SiOₓ layer, the power and pressure regulating the deposition process may also determine the resulting layer refractive index. Preferably, the over-cladding layer comprises, in addition and on top of the cap layer, an additional cladding layer—called the upper cladding layer—, having substantially the same refractive index than the cap layer. As a favourite embodiment, this upper cladding layer is realized in SiOₓ with 1≦×<2. Additionally, as a second preferred embodiment, the upper cladding layer material may comprise doped SiOₓ-based material, i.e. compounds containing besides SiOₓ the same dopants (C,F,N)—or a combination thereof—indicated as possibly included in the cap layer. More preferably, it comprises SiOₓ-based material doped with F.

The thickness of the cap layer is such that it maintains a height uniformity, and it depends, among others, on the overall grating's length. Preferably the cap layer thickness is comprised between 500 nm and 1500 nm, even more preferably between 700 nm and 1000 nm. The minimum thickness of 0.5 μm is the preferred lower limit to obtain a complete grating covering.

Cap layers exceeding about 1.5 μm may exhibit a thickness non-uniformity, which can be undesirable and may make an additional planarization step necessary. Additionally, since the cap layer's deposition process is a slow process in comparison to a standard deposition process, as it will become clearer in the following, it is preferred to deposit a cap layer not thicker than about 1.5 μm and to cover the cap layer by the upper cladding layer so as to reduce the total fabrication time. Applicants have noted that the power of the deposition process greatly influences the cap layer deposition speed.

The total thickness of the cap layer plus the additional upper cladding layer (i.e. the over-cladding thickness) is preferably such that the propagating mode in the waveguide is completely confined inside the waveguide itself. Symmetry is preferably respected, so that the thickness of the lower cladding below the core of the waveguide is substantially similar to the to the total thickness of the cap layer plus the additional upper cladding layer. Preferably, the cap layer has low stress properties, i.e. the compression stresses caused by the cap layer to the underlying layer(s) are low.

An additional goal of the present invention is to obtain a process to fabricate an optical device including a waveguide in which a buried grating comprising empty trenches is realized. In particular, the method of the invention includes a method step to deposit a cap layer on top of the empty trenches forming the grating without filling the trenches themselves.

According to the method of the invention, to realize the buried grating, a cap layer is deposited over the empty trenches using plasma chemical vapor deposition apparatus and the pressure and power of the plasma deposition process are so selected that the cap layer covering the trenches of the grating has poor gap fill properties.

These parameters (pressure and power) however also depend on the material in which the cap layer is made and on the type of plasma deposition process selected.

In a preferred embodiment of the invention, the cap layer is deposited using Plasma Enhanced Chemical Vapor Deposition (PECVD).

Additionally, preferably the cap layer is formed in a SiOₓ-based material. In particular, in a first preferred embodiment of the present invention, in order to form a SiOₓ-based cap layer, a feed gas containing silane and a fluorine source are introduced in a process chamber where the wafer is placed. These gases react and form the cap layer on the surface of the grating structure. Indeed the plasma has excited the silicon and fluorine gases and this allows the CVD reaction to occur. The pressure and power (in this case “power” means the power applied to coils of a plasma chamber in order to generate r.f. energy to create the plasma, while “pressure” indicates the pressure present inside the process chamber in which deposition occurs) of the deposition process are respectively comprised between 900≦P(Mtorr)≦1200 Mtorr and 80≦P(W)≦150 W. More preferably the silicon containing gas is silane (SiH₄) and the fluorine containing gas has the form of CₓF_{y}.

Other dopants among C, N or a combination thereof can be alternatively used instead of fluorine (also a combination of fluorine and C or N can be considered). However the power and the pressure of the process have to be selected according to the type of material which is to be deposited in order to achieve the desired cap layer characteristics.

Preferably, also an inert gas and oxygen gas are present in the process chamber. Inert gases may be selected among N₂, Ar, He and oxygen containing gases are for example: N₂O, O₂, CO₂.

According to a second preferred embodiment of the present invention, the cap layer comprises silicon oxide without additional dopants, i.e. the gas used in the plasma deposition are a silicon source, an inert gas and an oxygen containing gas.

In this case, the pressure and power of the deposition process are respectively comprised between 600 Mtorr≦P(Mtorr)≦900 Mtorr and 50 W≦P(W)≦100 W.

Preferably, the process temperature for the whole realization of the optical device after the grating trenches are formed is kept low, i.e. lower or equal than 400°0 C. Higher temperatures may deform the grating structure modifying its spectral response. Preferably the process temperature T is comprised between 250° C.≦T≦350° C. Therefore, both the cap layer deposition process step and subsequent wafer treatments are preferably realized at low temperature (below or equal to 400° C. as defined above). This implies that thermal annealing is preferably avoided during the fabrication of the optical device of the present invention. If appropriate, a thermal annealing at a temperature lower than 400° C. may be performed. Thermal annealing is generally performed in order to stabilize the optical and mechanical properties of the deposited layer and to reduce tensile stresses generated by the deposited upper layer on the underlying layers, i.e. to reduce birefringence. Additionally, thermal annealing generally changes the refractive index of the deposited layer, i.e. the refractive index of the layer as deposited is normally different from the refractive index of the film after annealing. Because annealing is preferably avoided in the method of the present invention for the reasons outlined above, the desired refractive index of the cap layer produced by the process of the invention is obtained immediately at deposition. In addition, to achieve the other layer characteristics obtainable by using an annealing phase, i.e. a film having low stress properties and the desired optical and mechanical characteristics, suitable parameters of the deposition process should be set accordingly.

A first possibility to reduce the stresses is adding fluorine as dopant. However in case of absence of fluorine (i.e. in case of a “pure” SiOₓ cap layer), Applicants believe that varying the deposition power (in particular reducing the same) the speed at which the elements that form the layer are deposited on the wafer is reduced (the deposition power “selects” how fast the molecules of the cap layer reach and link to the substrate on which they are deposited), thus reducing the overall stresses. Therefore also in case of a “pure” SiOₓ layer, the low stress layer properties can be achieved by duly selecting the power of the process as explained.

The outlined method can be used for example to fabricate a wavelength selective grating-based filter.

### BRIEF DESCRIPTION OF THE DRAWINGS

Further features and advantages of an optical device including a buried grating and of a method to realize an optical device according to the present invention will become more clearly apparent from the following detailed description thereof, given with reference to the accompanying drawings, where:

FIG. 1 is a schematic top-view of an optical device realized according to a preferred embodiment of the present invention;

FIG. 2 is a lateral section along the line A-A of the optical device of FIG. 1;

FIG. 3 is a lateral section along the line B-B of the optical device of FIG. 1;

FIGS. 4a and 4b are two graphs showing respectively the simulated and experimental exemplary optical characteristics of the optical device of FIG. 1. In each figure, the continuous lines represent the reflection and the transmission spectra;

FIG. 5 is a graph showing an example of an input signal to the optical device of FIG. 1;

FIG. 6 is a SEM perspective view partially sectioned of the optical device of FIG. 1;

FIGS. 7-14 are schematic cross-sectional lateral and upper views of different phases for the realization of the optical device of FIG. 1 according to an embodiment of the present invention;

FIGS. 15-22 are schematic cross-sectional lateral views of different phases for the realization of a detail of the optical device of FIG. 1 according to an embodiment of the present invention;

FIG. 23 is a SEM upper view graph of a detail of the optical device of FIG. 1.

### PREFERRED EMBODIMENTS OF THE INVENTION

With initial reference to FIGS. 1-3, 100 indicates an optical device including a buried grating 99 realized according to the teaching of the present invention.

The optical device 100 includes a planar waveguide 4 comprising a core 2 surrounded by a cladding 1, preferably realized on a substrate 3 such as a silicon wafer.

The substrate 3 may comprise a silicon based material, such as Si, SiO₂, doped-SiO₂, SiON and the like. Other conventional substrates will become apparent to those skilled in the art given the present description.

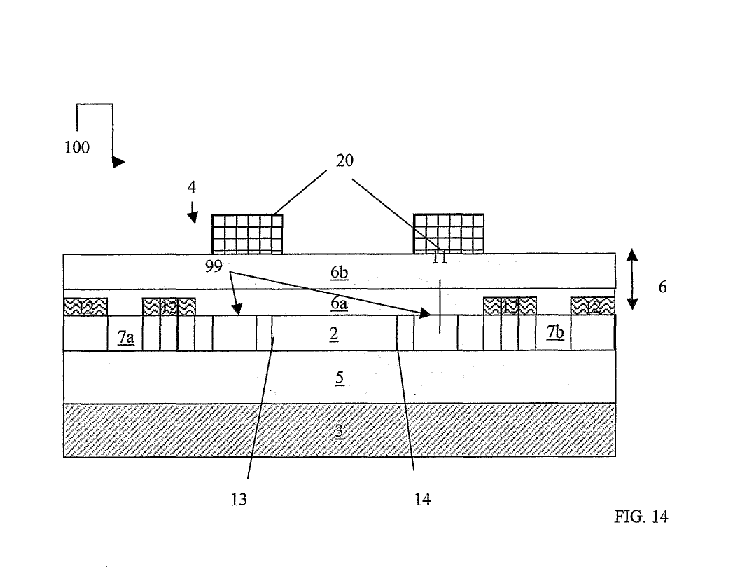

Three different portions of the cladding 1 can be identified, which can be more clearly seen in FIG. 14. To simplify the terminology in the following description, with the term “side of the core” a portion of the surface boundary between the core and the cladding will be indicated. In case of a core having rectangular or square cross-section, a side indicates a rectangular (or square) surface of the core; in case of a cylindrical core, a side indicates a portion of the cylindrical surface of the core.

With reference to FIG. 14, a lower cladding 5 is defined as the portion of the cladding 1 delimited between the substrate 3 and a side of core 2 approximately facing the substrate 3, i.e., the lower side. An over-cladding 6 is the portion of the cladding 1 placed above a side of the core 2 opposite to the substrate 3—i.e., the upper side—and above a lateral cladding 7, which is composed essentially by two distinct regions 7a, 7b separated longitudinally by the core 2. The lateral cladding 7 is essentially the remaining cladding portion sandwiched between the over and lower cladding 6, 5 which extends from the lateral sides of the core 2 in the two lateral (e.g. parallel to the substrate and perpendicular to the propagating direction) directions.

The planar waveguide 4 is preferably realized in semiconductor-based materials such as doped or non-doped silicon based materials and other conventional materials used for planar waveguides. Preferably, the core 2 of the waveguide may comprise a silicon based material, such as Si, SiO₂, doped-SiO₂, SiON and the like. The core refractive index n_{core} is preferably comprised between 1.448 and 3.5, while the cladding refractive index n_{cladding} is preferably comprised between 1.446 and 3.5. Therefore, the effective refractive index of the waveguide is preferably comprised between 1.448 and 3.5.

In a preferred embodiment of the invention, the core 2 is made in Ge-doped SiO₂ having a refractive index n_{core}=1.456, the lower cladding 5 is realized in undoped SiO₂ (refractive index n_{lower}=nᵤₚₚₑᵣ=1.446), whilst the lateral cladding 7 is realized in borophosphosilicate glass (BPSG, which is silicon dioxide in which boron and phosphorus are added). BPSG has a refractive index substantially identical to that of undoped SiO₂. It is understood that other materials may be employed as known by those skilled in the art. BPSG is preferred as material for the lateral cladding because of its good gap-filling capability.

Preferably, the refractive indices of the lower and lateral cladding 5, 7 are substantially identical one another, i.e. the difference between the refractive indices of the lower and lateral cladding is of the order of 10⁻⁴ or lower.

Additionally, the refractive index of the core 2 is higher than the refractive index of the lower, over and lateral cladding layers, 5, 6, 7, respectively.

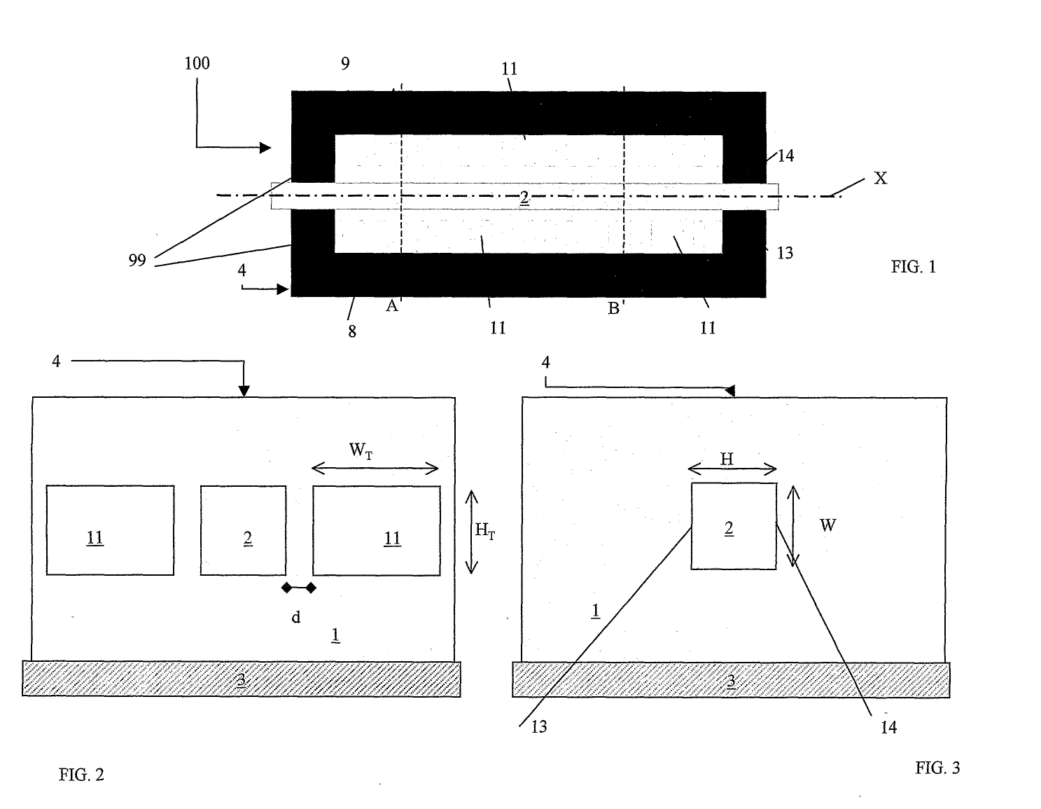

As shown in FIGS. 2 and 3, preferably the core 2 of the waveguide 4 has a square cross-section. This geometry advantageously renders the device polarization-independent. Also a circular cross-section might achieve the same goal.

Preferably, the width W and the height H of the core 2 are both comprised between 1 and 9 μm, for example in the embodiment of FIGS. 2 and 3 the core 2 has a cross section of 4.5×4.5 μm².

A grating structure 99, in particular a buried grating structure (i.e. a grating completely surrounded by the core and/or the claddings of the waveguide), is realized in the optical device 100. This grating structure can be realized on the core of the waveguide, in the cladding of the same or in both core and cladding. The core 2 and the lateral cladding 7 define a portion of the waveguide which will be indicated in the following to as the guiding layer. Therefore it can be shortly said that the grating structure 99 is realized in the guiding layer. In the example of FIGS. 1-3, the grating structure 99 comprises two plurality of trenches 8 and 9 realized in the lateral cladding 7, respectively in regions 7a and 7b. However, a single plurality of trenches may be realized, for example on top of the core 2 of the waveguide.

In particular, each plurality of trenches—each trench being indicated with 11 and all trenches being preferably parallel one another—, is located in the proximity of a lateral side 13, 14 of the core 2 of the waveguide 4 (FIG. 14). The first and second plurality of trenches 8 and 9 are realized along the core 2, preferably symmetrically with respect to a longitudinal axis X of the core 2.

The number of the pluralities of trenches realized on the core/cladding of the planar waveguide 4 can be one, two or higher than two and it depends on the desired filter application.

The grating trenches 11 are “empty”, e.g., left under vacuum, filled with air or with another gas, such as an inert gas.

Preferably, the trenches 11 are filled with air (nₐᵢᵣ=1), so that the refractive index contrast Δn_{G} in the grating along the propagation direction (which is the X axis) of a mode in the waveguide 4 is rather high. More preferably, the material in which the lateral cladding is formed and the gas filling the trenches are chosen so that Δn_{G}≧0.4. For example, in case of a cladding made of undoped silica and trenches filled with air, Δn_{G} is of about 0.446. Preferably, the grating structure is configured so as to obtain an effective index contrast of 1×10⁻⁴≦Δn_{eff}≦2-3×10⁻³.

In a preferred embodiment of the invention (see FIG. 2), trenches 11 have the same height H_{T} as the core 2. However any trench height can be chosen, as soon as the trenches 11 are confined within the cladding 1. The width W_{T} of the trenches 11 (i.e. their dimension perpendicular to the X axis extending in the lateral cladding, see for example FIG. 2) is preferably higher than 500 nm and more preferably comprised between 0.5 μm and 10 μm.

The period Δ_{grating} of the grating structure, i.e. of the pluralities of trenches 8, 9 realized in the cladding 1 of the waveguide 4, is preferably comprised between 100 nm and 600 nm. Additionally, the grating duty cycle is preferably comprised between 10% and 90%. In a preferred embodiment, Λ_{grating}=536 nm and duty cycle of 50%.

According to a particular characteristic of the present invention, the over-cladding layer 6, comprises a cap layer 6a, which covers the trenches 11 of the grating structure 99, so that the grating 99 results buried in the waveguide. It is important, in order not to perturb and introduce noise in the optical response of the device 100, that the material in which the cap layer 6a is formed does not enter inside the trenches 11. On the contrary, the cap layer has to cover the trenches forming bridges between the tops of adjacent trenches. This plurality of adjacent bridges forms a continuum which is the substantially flat cap layer 6a. Therefore, the cap layer 6a has poor gap filling properties. These properties are achieved controlling the parameters of the cap layer deposition process.

Preferably, the cap layer 6a comprises silicon oxide or, in an additional embodiment of the invention, doped silicon oxide. More precisely, the cap layer preferably comprises a SiOₓ-based material which may include one or more dopants selected among carbon (C), nitrogen (N), fluorine (F) or a combination thereof. More preferably, the cap layer comprises either undoped silicon oxide or fluorinated silicon oxide.

Alternatively, organic Silicon Glass Oxide (SOG) can be selected for the cap layer deposition.

Additionally, the difference in refractive index between the refractive index of the lateral cladding 7 and the cap layer 6a is of the order of 10⁻⁴ or lower. Preferably, the refractive index difference is ≦3×10⁻⁴. A higher difference in refractive indices may lead to an introduction of high propagation losses in the optical device because the optical mode traveling in the waveguide is not properly confined.

A sub-stoichiometric silicon compound is preferred in order to obtain the desired refraction index of the cap layer as deposited.

Preferably, as it is better shown in FIG. 14, the over-cladding layer 6 comprises an additional upper cladding layer 6b, which is located on top of the cap layer 6a. The material in which the upper layer 6b is realized has substantially the same refractive index than the cap layer 6a. Preferably, the upper cladding 6b is realized in a SiOₓ-based material which may be “pure” or may eventually include one or more of the above listed dopants (i.e. the dopants which may be included in the cap layer forming material). More preferably, the upper cladding layer 6b comprises either undoped silicon oxide or fluorinated silicon oxide.

The thickness of the over cladding layer 6, i.e. the sum of the thickness of the cap layer 6a and the upper cladding layer 6b, is preferably chosen such that a mode propagating in the waveguide 4 is substantially wholly confined inside the waveguide 4 itself. Therefore the preferred thickness depends on the device's characteristics, such as the material in which the waveguide is realized and its geometry.

The thickness of the cap layer 6a is preferably chosen such that the layer keeps a good height uniformity. Indeed, due to the deposition process, a cap layer having a thickness larger than 1.5 μm may form picks and valleys which may require a further planarization. Additionally, the cap layer deposition process is rather slow and therefore relatively thick cap layers require long fabrication time.

In order to avoid these dishomogenieties and increase of fabrication time, the thickness H_{cl} of the cap layer is preferably comprised between 0.5 μm ≦H_{cl}≦1.5 μm, even more preferably between 0.7 μμm≦H_{cl}1.0 μm. The thickness of the upper cladding 6b then follows to achieve a total thickness as indicated above. Symmetry is preferably preserved, the total thickness of the over-cladding 6 is preferably substantially the same (the wording “substantially the same” indicates that fabrication tolerances have to be considered) as the thickness of the lower cladding 5 so that the mode traveling in the core 2 is centered in the core itself and not shifted towards a specific region.

Preferably, the total thickness given by the sum of the thickness of the cap layer (6a) and the upper cladding layer (6b) is comprised between 7 μm and 10 μm.

In a preferred embodiment depicted in FIGS. 1 and 14, the two pluralities of trenches 8 and 9 are positioned in proximity to the two opposite lateral sides of the core 13, 14 so as to induce a perturbation of the optical mode propagating along the waveguide.

In this example, no grating structure is located in the core of the waveguide. The grating is only formed in the cladding of the same.

The term “in proximity” of the core indicates that the distance between the core of the waveguide and each plurality of trenches should be such that the grating structure can perturb the optical mode propagating in the waveguide, as it will become clearer in the following.

The pluralities of trenches 8,9 of the device are located in the cladding

layer(s) so as to create a perturbation effect on the optical modes which travel in the waveguide. Guided optical modes in waveguides are not completely confined inside the core 2, but their spatial distribution extends also in the cladding region 7. In particular, an evanescent field that generally decays as an exponential function of the distance from the core-cladding interface propagates in the cladding.

This evanescent field is modified by the presence of the grating formed in the lateral cladding and therefore the mode itself is affected by the grating. Being the electro-magnetic field intensity of the mode in the cladding rather low with respect that of the core, higher tolerances are acceptable in the grating fabrication so that it becomes easier to control the grating parameters in a cladding-positioned grating than in a grating realized in the core region of the same waveguide.

Preferably, the wavelength filter is highly selective, i.e. it has a bandwidth ranging from about 10 to 400 GHz.

Preferably, the wavelength filter has a high reflectivity, i.e. higher than 99%. It is known that to obtain these characteristics, the perturbation due to the grating structure on the propagating mode has to be weak. However, due to the fact that the grating structure 99 of the present filter 100 perturbs only the evanescent field of the propagating mode, the grating structure has preferably a relatively high index contrast Δn_{G}, i.e. Δn_{G} is higher than or equal to 0.4. It is to be understood that the coupling between the grating and the lateral evanescent field depends also on the lateral distance, d, of the trenches from the sides of the core. A refractive index contrast Δn_{G} of not less than 0.4 can lead to a weak but effective perturbation, i.e. of about 1×10⁻⁴≦Δn_{eff}≦2-3×10⁻³.

The distance between the trenches and the lateral sides of the core of the waveguide, d, is preferably not smaller than 50 nm. The lower limit is due to the fact that realization of a grating located extremely close to the core/cladding boundary is technologically complex and requires high accuracy. More preferably, d≧100 nm, even more preferably d is in the range from 100 to 1000 nm.

An optimum value of d is preferably to be determined on a case-by-case basis, because it depends, among others, on the desired spectral response of the filter and on the materials in which the core and claddings are realized.

Preferably, the two pluralities of trenches 8, 9 are realized symmetrically with respect to the longitudinal axis of the core. Due to this preferred configuration, losses due to coupling of light from the guided core mode to cladding modes are advantageously minimized.

Preferably, the two sets of trenches of the grating structure are realized simultaneously to avoid misalignments and to minimize stitching errors, which could degrade the spectral response.

The cross-section of the core of the planar waveguide included in the filter of the invention is preferably square, so that the filter is polarization-independent.

The described optical filter includes a Mach-Zehnder interferometer (MZI). The MZI includes two arms in both of which a grating structure is realized in the cladding as above described.

A cascade of a plurality of filters, for example of MZIs, is realized in order to obtain a multichannel add/drop signal optical device.

In accordance with another aspect of the present invention, the optical device 100 is preferably tunable, i.e. the Bragg wavelength filtered by the grating structure 99 is changeable. Even more preferably, the optical device 100 is thermo-optically tuned.

It is known that several materials change their refractive index with temperature. Changing the refraction index of the core or the cladding (or both) of a waveguide implies that also its effective index and thus the selected Bragg wavelength changes: λ_{B}=2n_{eff}Δ(z).

In particular, in the present case heaters 20 (an example of which is shown in FIGS. 14 and 22) are placed on top of the cap layer 6a (or on top of the upper cladding layer 6b) approximately in correspondence of the grating region to heat the same. The heaters 20 may be for example electrodes of a specific resistance.

Preferably, the operating temperature range of the grating structure 99 is of about from 0° C. to 250° C., even more preferably between 20° C. to 100° C. Given this second temperature range, the shift in the Bragg wavelength can be of about 1.2 nm.

### EXAMPLE 1

With reference to FIGS. 1-3 and 14, the lower cladding 5 is realized in SiO₂ with a thickness of 10 μm and a refractive index of n_{lower}=1.446, and it is deposited on a silicon wafer 3.

The core 2, having a 4.5×4.5 μm² cross-section, is realized in Ge-doped SiO₂ (n_{core}=1.456).

The lateral cladding 7 is realized in BPSG, having a refractive index of nₗₐₜₑᵣₐₗ=1.446.

The cap layer 6a, having a thickness of 1 μm, is realized in fluorinated silicon oxide having a refractive index of n_{cap}=1.446. The upper cladding layer 6b has a thickness of 9 μm and is realized in SiOₓ.

The first and second plurality 8, 9 of grating trenches 11 forming the grating structure have a width W_{T} of 3 μm and a height H_{T} of 4.5 μm, and are filled with air (nₐᵢᵣ=1). Therefore the refractive index difference is Δn_{G}=0.446.

The distance of the trenches 11 from the core is d=500 nm. The grating period is equal to 536 nm with a duty cycle of 50%.

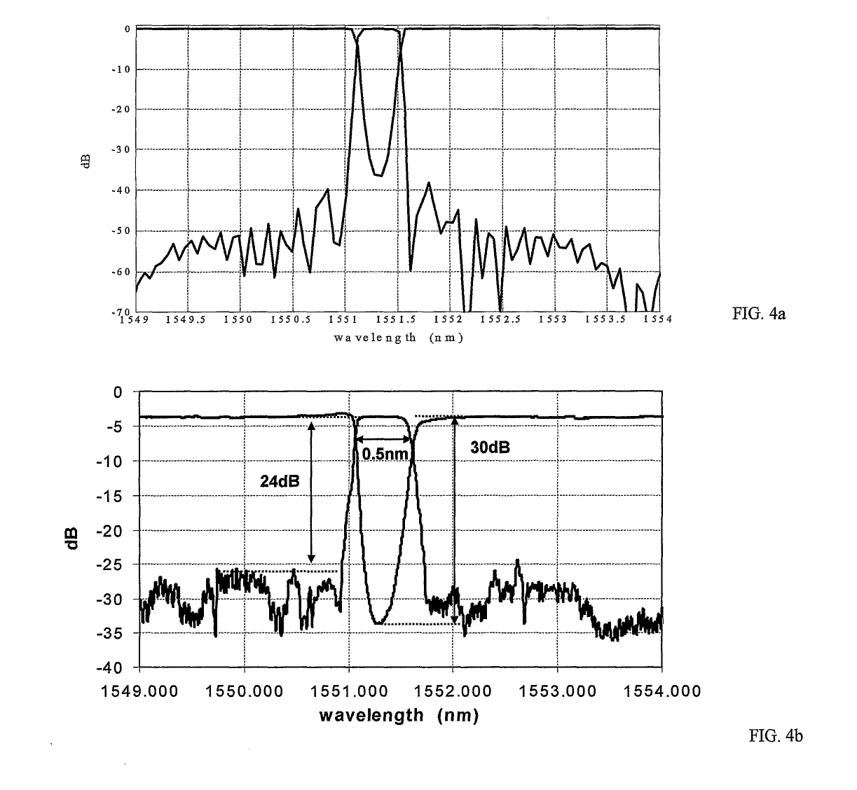

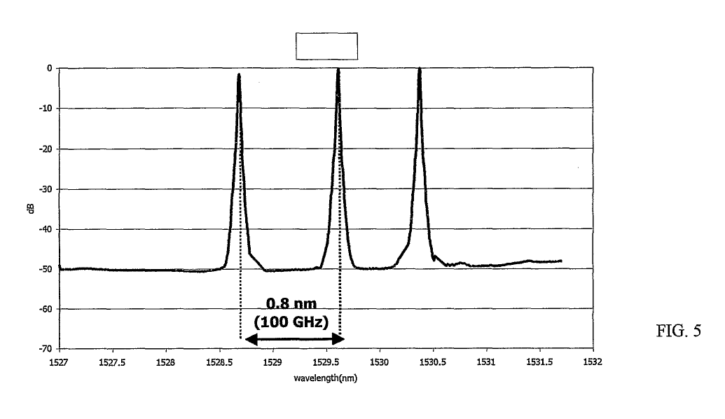

Considering an input signal applied to an input port of the optical device 100 comprising a plurality of channels having wavelengths spaced apart as depicted in FIG. 5, the optical response of the optical device 100 so realized as described in this example is shown in FIGS. 4a and 4b.

In particular, the two solid lines drawn in each figure show the simulated (FIG. 4a) and experimental (4b) transmission spectrum and reflection spectrum of the optical device.

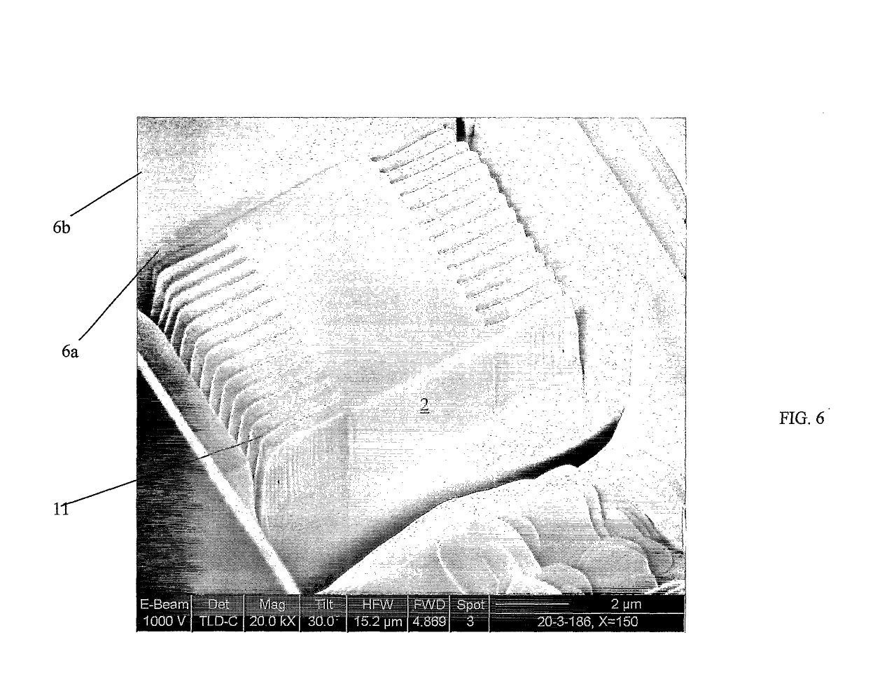

A SEM picture, obtained by Focused Ion Beam (FIB) technique, of the realized device 100 is shown in FIG. 6. The optical device 100 is partially sectioned in order to show the trenches 11, the cap layer 6a and the upper cladding layer 6b.

With reference now to FIGS. 7-14, fabrication of the planar waveguide 4 of the invention according to a preferred embodiment of the invention is described. A lower cladding layer 5, for example of undoped SiO₂, is deposited on the substrate 3. A core layer 2′ is thus deposited on top of the lower cladding layer 5. The core and lower cladding layers may be deposited according to any suitable standard technique such as Chemical Vapor Deposition (CVD).

A masking layer 12 is then deposited on top of the core layer 2′, in order to protect the latter layer during the subsequent etching process. Any masking material selective on the core layer material may be used, for example a polysilicon layer may be employed, which is deposited for example by Low Pressure Chemical Vapor Deposition (LPCVD). This configuration is shown in FIG. 7.

The patterning of the core layer 2′ in order to obtain the core 2 of the waveguide 4 is thus realized by optical lithography using the masking layer 12 as a mask after appropriate patterning. For example the core 2 may be patterned using a dry etching phase.

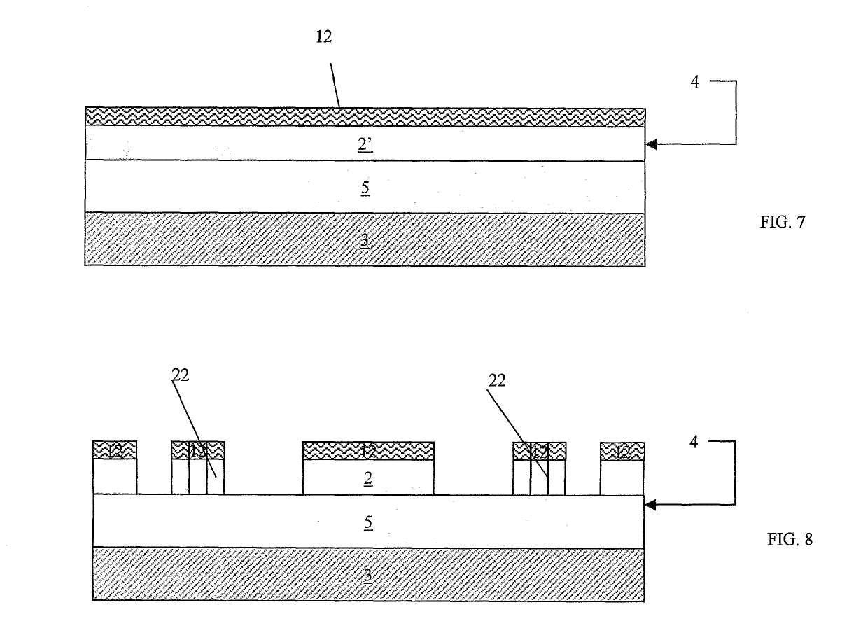

During the same etching step, preferably also aligning markers 22 are defined (see FIG. 8), the use of which will be described in the following. These aligning markers 22 are preferably cross-shaped.

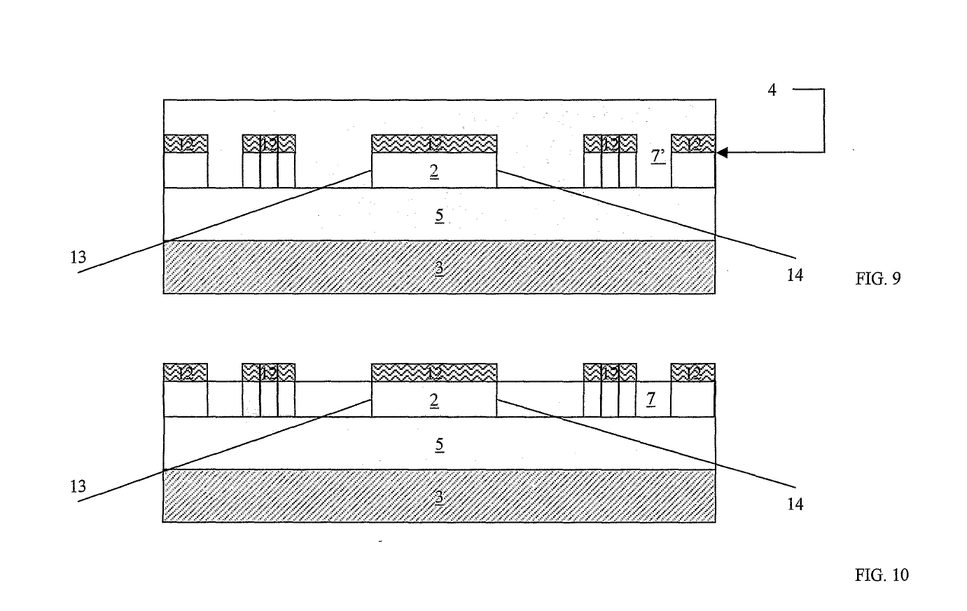

A lateral cladding layer 7′, for example realized in BPSG, is then deposited on top of the patterned core 2 and aligning markers 22, in particular on top of the remaining portions of the masking layer 12 used to etch the core 2 and markers 22, and on top of the lower cladding layer 5, as shown in FIG. 9.

Preferably, after deposition, the top surface of the lateral cladding layer 7′ is planarized. A standard planarization technique might be used, such as Chemical Mechanical Polishing (CMP).

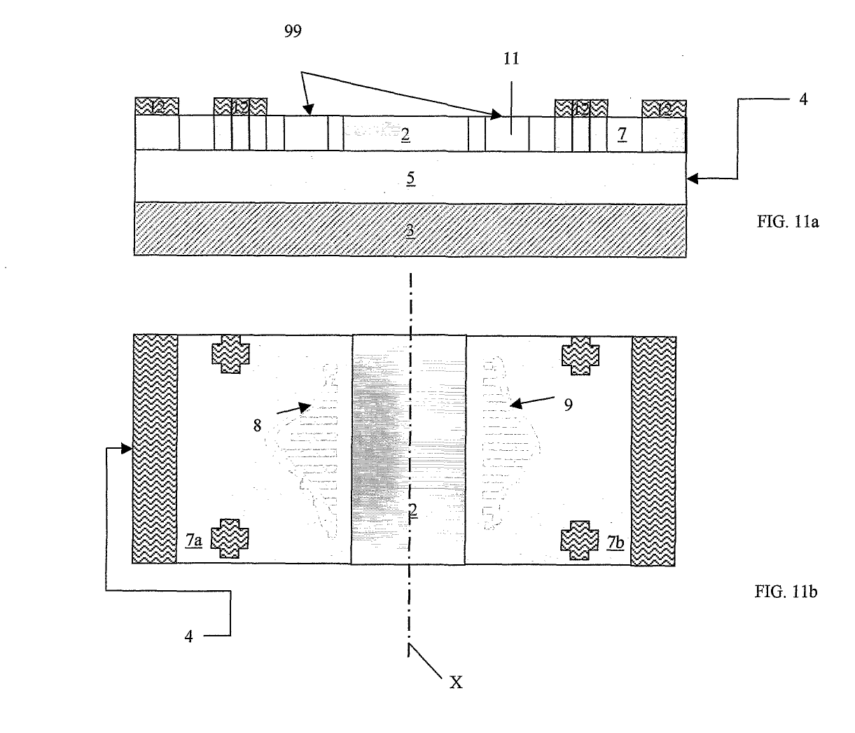

The lateral cladding layer 7′ is then etched in order to reduce its thickness up to the height of core 2, to obtain the lateral cladding 7 (FIG. 10). The lateral cladding 7 is divided in two portions 7a and 7b by the patterned core 2. Preferably, a portion of the masking layer 12 still covers the core 2 and markers 22 during this etching phase, and it is subsequently removed only from above the core 2: at the end of this step, portions of the masking layer 12 in polysilicon still cover the alignment markers 22 (see FIGS. 11a and 11b. In the latter figure, the separation of the lateral cladding 7 in two distinct regions 7a and 7b is clear).

The trenches 11 forming the two pluralities 8, 9 are preferably realized on the lateral cladding layer 7 using electron beam lithography, although sub-micron optical-lithography can be used as well. Even if in all appended figures the grating trenches are realized exclusively on the lateral cladding of the waveguide, they can be formed in any region of the guiding layer, i.e. either in the core or in the lateral cladding or in both of these. The teachings of the present invention apply without modifications to all these cases.

The lateral cladding layer 7 is therefore covered by a resist (not shown) suitable for use in electron beam lithography. The resist layer can be for example a positive resist layer made of UV6™. As an example, the thickness of the UV6™ layer is equal to 1.7 μm.

According to a second embodiment of the present invention, instead of a single resist layer, a resist multi-layer may be used. Preferably, a three-layer resist is realized. This embodiment is preferable when a grating having high aspect ratio is desired. Indeed, a suitable resist preferably needs to have not only dimensional control on different type of geometries, but also proper etching selectivity and roughness control on deep vertical profiles. The three-layer resist of the present invention is a possible solution of providing a suitable resist to enhance the depth reached during the plasma etching process of the optical layer by the combined usage of materials having different chemical properties.

Therefore, the electron beam transfers the desired pattern (the lines of the trenches 11) onto the resist layer(s) during the writing process. Preferably, the two gratings patterns are realized at the same time. More generally, multiple desired patters are created in a single writing process.

The desired pattern may include parallel lines with a constant pitch, as in the preferred embodiment depicted in FIG. 1, however in other embodiments the pattern may include other configurations of parallel lines. For example, in the embodiment of FIGS. 11b-13b an apodized grating structure is realized by maintaining a constant pitch and modulating the length of the trenches along the grating total length.

In order to place the two plurality of trenches 8, 9 on both sides of the waveguide core 2 with a sufficient accuracy, an alignment procedure of electron beam lithography is preferably followed, making use of the polysilicon markers 22 created during the waveguide core 2 definition.

The advantage of using the markers 22 is rather independent from the deposition of the cap layer 6a (the markers can be used in all cases in which multiple structures need to be aligned on any type of layer) and allows an accurate alignment of multiple grating structures.

The resist layer is thus developed in a standard way to resolve the grating patterns. The patterns are then transferred in the lateral cladding layer 7 by Deep Reactive Ion Etching using the resist mask patterned using e-beam to protect the un-etched portions. The resulting configuration is shown in FIGS. 11a, 11b in which the trenches lines 11 are visible in cross-section and from above respectively. The so realized trenches are empty, i.e. filled with air, vacuum or other gases.

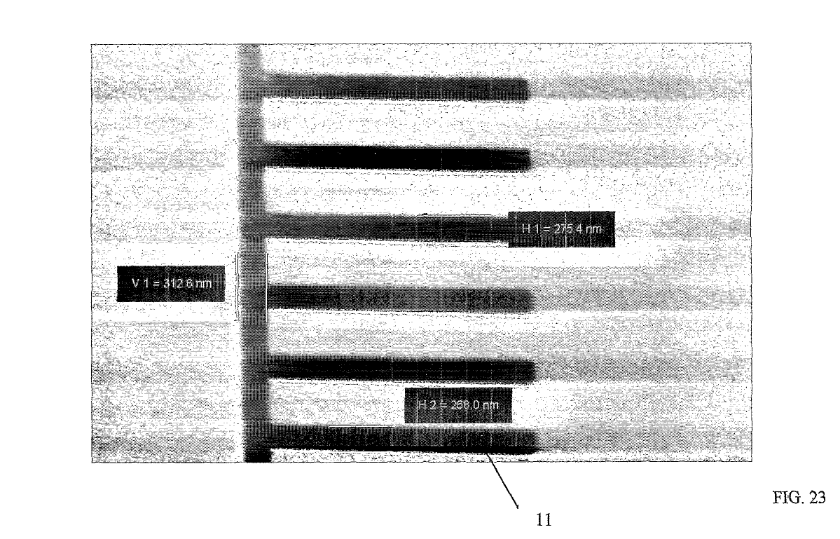

In FIG. 23, a SEM picture of an example of a grating pattern, obtained according to the above described method and with the use of a three-layer resist, is shown.

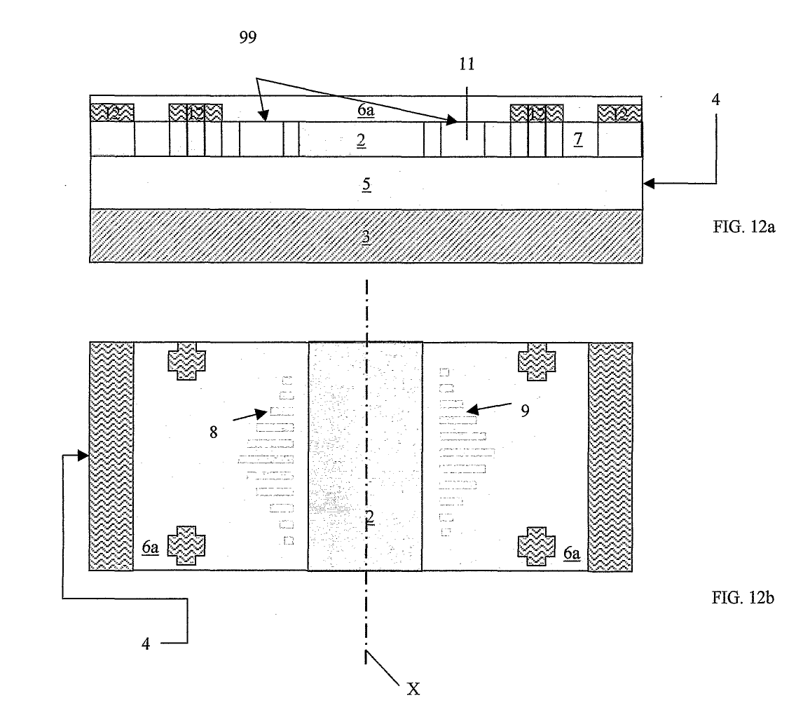

According to a characteristic of the present invention, a cap layer 6a is thus deposited over the so-formed empty trenches 11, realizing a buried grating structure 99, and over the core 2 of the waveguide 4. This phase is shown in FIGS. 12a and 12b. The deposition of the cap layer 6a is made in such a way that the filling of the trenches 11 by portions of the cap layer material is essentially avoided.

In order to obtain the above outlined characteristics of the cap layer 6a, i.e. its extremely poor gap filling properties in order not to fill the trenches, the pressure and power of the deposition process are properly controlled. Having selected a proper pressure and power, which depend on the material in which the cap layer is realized and on the type of deposition process selected, the deposition of the cap layer is performed in such a way that the free mean path of the deposited particles is as small as possible so that they remain in the place where they are deposited “immediately” linking with the neighboring particles, thus minimizing any particle movements that may cause their entrance inside the trenches.

Preferably the cap layer 6a is deposited by Plasma Enhanced Chemical Vapor Deposition (PECVD), however other techniques may be employed, such as Atmospheric Pressure Chemical Vapor Deposition (APCVD) or Sub-atmospheric Pressure Chemical Vapor Deposition (SACVD). Processes such as Low Pressure Chemical Vapor Deposition (LPCVD) are preferably avoided due to the high temperatures involved.

Preferably, the cap layer 6a is realized either in silicon oxide, i.e. SiOₓ with 1≦×<2 or in doped silicon oxide, i.e. in a SiOₓ-based material including a dopant. Preferred dopants are fluorine, carbon, nitrogen or a combination thereof. More preferably, the cap layer comprises “pure” SiOₓ or a SiOₓ-based material including fluorine.

In a preferred embodiment, the starting process gasses are a silicon-containing gas and a fluorine containing gas. These gases streams, introduced at a suitable flow rate into a process chamber where the wafer is placed, mix and are associated and activated by a plasma which is also introduced in the process chamber. In this particular state, the silicon and fluorine gaseous chemicals react to form a layer of fluorinated silicon oxide (the cap layer 6a) on top of the empty trenches 11.

According to a first preferred embodiment of the invention, Silane (SiH₄), a fluorine source (CₓF_{y} such as CF₄) and Nitrous oxide (N₂O) are introduced in the process chamber. However any other silicon-containing gas and oxygen-containing gas may be present.

In this embodiment of the invention the chemical reaction can be generally represented by:

SiH₄+CF₄+N₂O [symbol] SiOFₓ+SiH_{y}+CN+CO+NO_{z}+OH⁻+H⁺

The pressure in the deposition chamber, called depositing pressure, is set at about few hundred millitorr, in particular preferably between 900≦P(Mtorr)≦1200 Mtorr and the power to be applied to the gas particles to obtain the plasma status is of about 80≦P(W)≦150 W.

According to a second preferred embodiment of the invention, the fluorine source may be absent and the process gasses comprises preferably Silane and Nitrous oxide.

In this case, the pressure in the deposition chamber is set preferably between 600 Mtorr≦P(Mtorr)≦900 Mtorr and the power to be applied to the gas particles to obtain the plasma status is set between 50 W≦P(W)≦100 W.

The final cap layer 6a results to have a refractive index value preferably comprised between 1.4420 and 1.446, when measured at a wavelength of λ=1550 nm.

The temperature of the process chamber during the deposition of the cap layer 6a, either in the first or in the second preferred embodiment, is preferably kept relatively low, i.e. lower or equal than 400° C. and even more preferably is comprised between 250° C. and 350° C. Higher temperature may deform the underlying trenches 11 and the response of the grating structure 99 would be unpredictable.

For the same reason, annealing with T above 400° C. is preferably avoided in the method of the present invention. Thermal annealing is often employed in order to reduce the compressive stress of a deposited layer on the underlying layer and to control birefringence. Generally, annealing temperatures are well above the maximum grating tolerated temperature. Therefore, it is important for the cap layer to exhibit low film stress without the need of a subsequent annealing step, low stress properties which are achieved thanks to the chosen characteristics and parameters of the deposition process itself and, in case, to the fluorine—or other dopants—presence in the cap layer material.

Applicants suppose that the deposition power strongly influences the resulting cap layer stress properties. A relatively low power during deposition probably reduces the cap layer stresses.

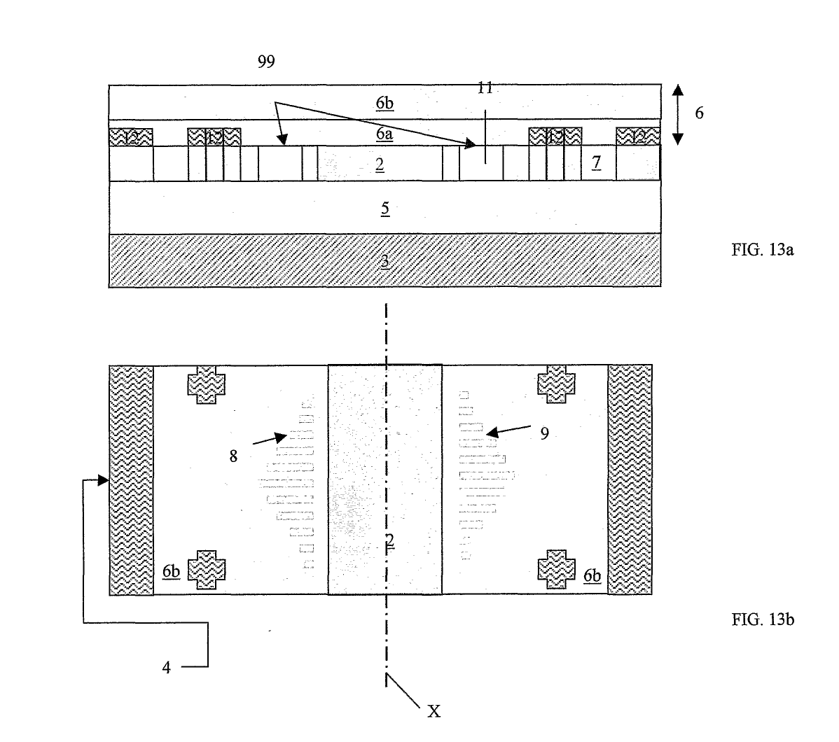

An upper cladding layer 6b (see FIGS. 13a and 13b) is then preferably deposited on top of the first layer 6a, in order to form the over-cladding 6, so that the overall thickness of the over-cladding layer 6a+6b is of the order of the lower cladding layer 5. Preferably the upper cladding layer 6b is made of a SiOₓ-based material (as explained above) which may or may not include a dopant selected among fluorine (F), carbon (C), nitrogen (N) or a combination thereof and its refractive index is substantially identical to the refractive index of the cap layer 6a. See for example FIG. 14 for the resulting configuration.

In this way, having a symmetric structure, the optical mode traveling in the waveguide is centered in the core 2 and is surrounded by a cladding having the same refractive index in all spatial directions, minimizing propagation losses.

Preferably, in order to form the above mentioned microheater(s) 20 to tune the grating structure, a metallic layer is deposited on top of the upper cladding layer 6b on which metallic contacts 20 are thus patterned (FIG. 14).

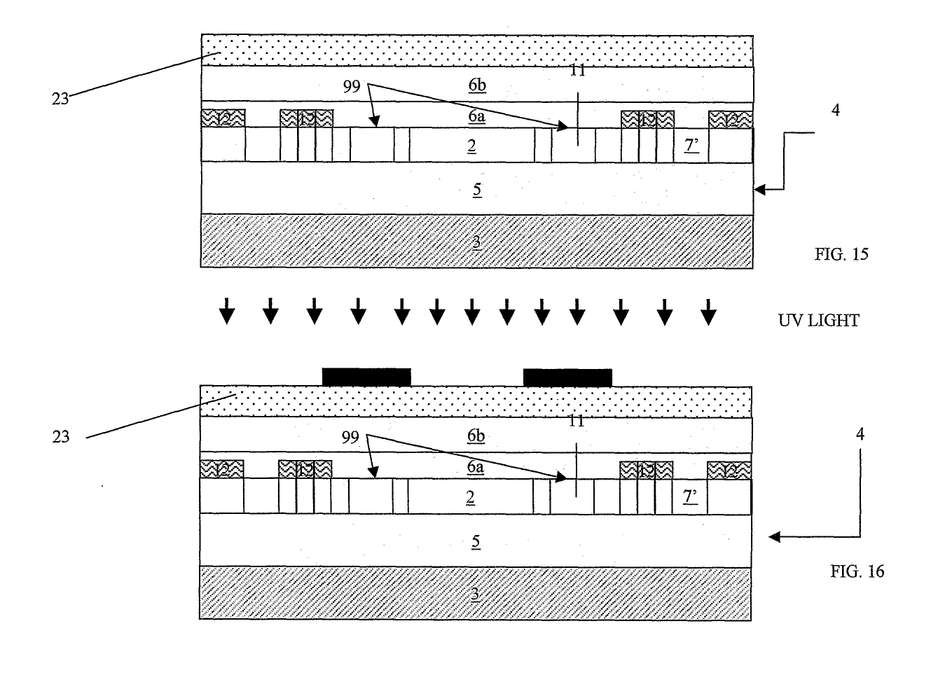

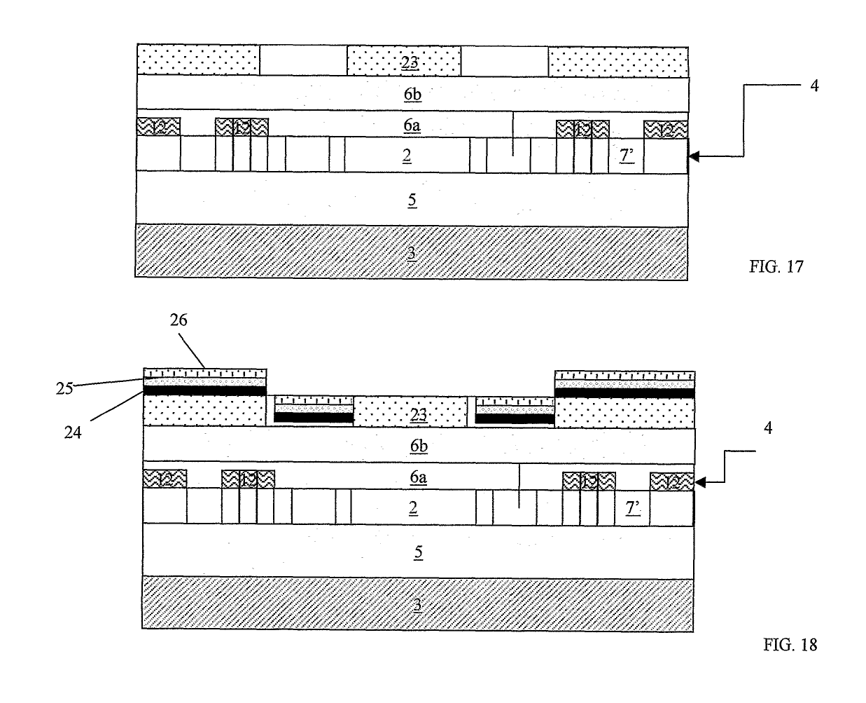

More in detail, to obtain the contacts 20, the upper cladding 6b is coated by a photoresist 23, for example AZ 5214 from Clariant GmbH 3 μm thick (FIG. 15). The photoresist is thus UV-exposed using a suitable mask (FIG. 16) and the develop process to reveal the photolithographic pattern is performed on a solvent bench (FIG. 17).

After the lithographic process, a metal layer, which will be patterned to form the microheaters 20, is deposited on the portions of the upper cladding layer 6b free from the photoresist layer 23 and on top of the remaining portions of the photoresist layer itself. In particular a metal three-layer is formed: as an example, a Titanium layer 24, a Platinum layer 25 and a Gold layer 26 are realized (see FIG. 18).

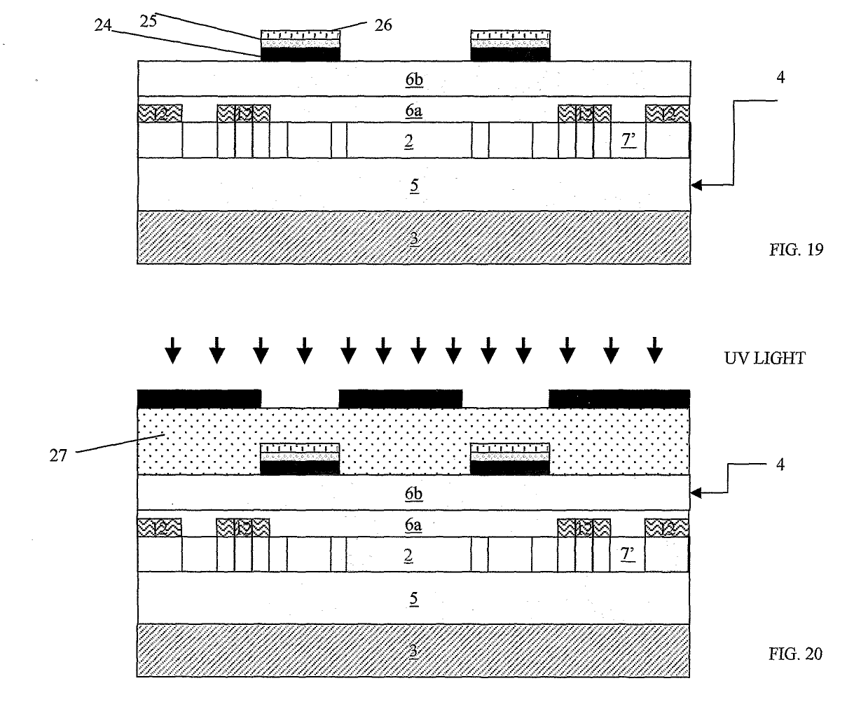

A lift-off step then follows, in which the metal is kept only in the heaters region, removing the additional metal and the underlying photoresist 23 chemically. This step is depicted in FIG. 19.

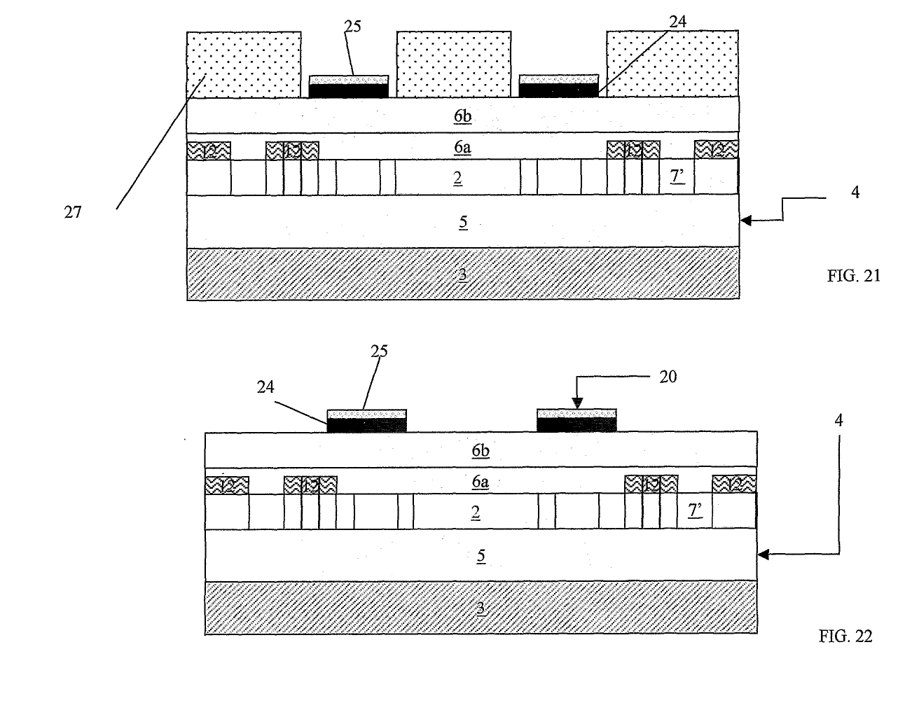

After the lift-off process, a photoresist layer 27 is deposited over the wafer and it is then exposed by UV light (see FIG. 20). Then the photoresist layer 27 is developed. A selective Gold etch is then performed, removing the gold layer 26, so that in the heater region only the Ti/Pt layers 25, 26 are left (see FIG. 21).

After the metal etch, the residual photoresist layer 27 is removed with a bath immersion in a remover and with a second bath in a cleaner. The resulting configuration is depicted in FIG. 22.

### EXAMPLE 2

An optical device 100 is realized following the process outlined below.

On top of a silicon wafer 3, a SiO₂ layer (the lower cladding 5) is realized by thermal oxidation, having a thickness of 10 μm. On top of this layer, a core layer 2′ which is made of Ge-doped SiO₂ and which has a thickness of 4.4 μm, is deposited using PECVD.

The core layer 2′ is thus covered by a polysilicon layer 12, 0.5 μm thick, deposited using LPCVD. The polysilicon layer 12 and the core layer 2′ are thus patterned using a dry etching technique.

The BPSG lateral cladding layer 7′ is then deposited by Atmospheric Pressure Chemical Vapour Deposition (APCVD) on top of the core 2 and lower cladding 5, with an initial thickness of 8.5 μm, and it is then planarized using CMP. The BPSG layer in excess is then removed through etching (etchback phase) up to the core height.

The portion of polysilicon layer remained on top of the core 2 is thus removed.

The trenches 11 are realized using electron-beam lithography. In particular a resist layer made of UV6 having a thickness of 1.7 μm is deposited on top of the BPSG lateral cladding, which is then patterned by e-beam. A Deep Reactive Ion Etching (DPRIE) phase realizes the two pluralities of trenches 8, 9 forming the grating structure in the BPSG layer.

Using Plasma Enhanced Chemical Vapour deposition, a silicon oxide layer 6a containing fluorine atoms is deposited on top of the core 2 and lateral BPSG cladding layer 7 (and thus over the trenches therein formed), forming the cap layer 6a. The thickness of this layer is 1 μm.

The following gasses has been used in the cap layer deposition process:
SiH₄ having a flow rate of 17 sccm
CF₄ having a flow rate of 34 sccm
N₂O having a flow rate of 2000 sccn.

The process parameters have been set as indicated below:
Tplaten/Tshowerhead=300/250 C.
Pressure=900 mtorr
Power at 13.56 MHz is set at 150 W.

A SIOF upper cladding layer 6b having a thickness of 9 μm is deposited on top of the first layer 6a. For this deposition process, it has been used:
SiH₄ at 17 sccm
CF₄ at 34 sccm
N₂O at 2000 sccn.

The process parameters have been set as indicated below:
Tplaten/Tshowerhead=300/250° C.
Pressure=300 mtorr
Power at 380 KHz=700 W

A metal layer (see FIGS. 17-22) is deposited on top of the upper cladding layer 6b and microheaters 20 are patterned.

### EXAMPLE 3

The optical device 100 is realized as outlined in Example 2 with the exception of the cap layer 6a which does not contain fluorine. The cap layer's deposition steps are as follows:

### Gas Used:

SiH₄ at 17 sccm
N₂O at 2000 sccm

### Process Parameters:

Power: 80 W
Pressure: 980 mTorr

A SiOF upper cladding layer 6b having a thickness of 9 μm is deposited on top of the cap layer 6a. For this deposition process, it has been used:
SiH₄ at 17 sccm
CF₄ at 34 sccm
N2O at 2000 sccn.

The process parameters have been set as indicated below:
Tplaten/Tshowerhead=300/250° C.
Pressure=300 mtorr
Power at 380 KHz=700 W.

Using the method of the invention above outlined, the cap layer 6a remains above the trenches 11 and it does not enter in the same, as visible from FIG. 6.

1-39. (canceled)

40. An optical device comprising a waveguide, said waveguide comprising
a core surrounded by a cladding, said cladding comprising a lower cladding, the core being placed above the lower cladding, a lateral cladding adjacent to a first and a second opposite lateral sides of the core, and an over-cladding, said over-cladding being positioned above said core and lateral cladding, wherein said core and lateral cladding define a guiding layer and said over-cladding comprises a cap layer, said cap layer having a first refractive index; and
a grating structure formed in said guiding layer, said grating structure comprising a plurality of empty trenches, and said cap layer being in contact with said grating structure,
wherein said first refractive index of said cap layer is substantially identical to the refractive index of the lateral cladding in contact with said cap layer, said cap layer being located above said trenches and forming bridges connecting each couple of adjacent trenches of said plurality so that the material forming said cap layer does not enter into said trenches.

41. The optical device according to claim 40, wherein said over-cladding comprises an upper cladding layer on top of said cap layer.

42. The optical device according to claim 40, wherein said cap layer comprises silicon oxide.

43. The optical device according to claims 40, wherein said cap layer comprises a silicon oxide-based material doped with fluorine.

44. The optical device according to any of claim 40, wherein said cap layer comprises a silicon oxide-based material doped with carbon.

45. The optical device according to claim 40, wherein said cap layer comprises a silicon oxide-based material doped with nitrogen.

46. Optical device according to claim 40, wherein the thickness of said cap layer is 500 nm to 1500 nm.

47. The optical device according to claim 46, wherein the thickness of said cap layer is 700 nm to 1000 nm.

48. The optical device according to claim 40, wherein the thickness of said lower cladding is substantially equal to the thickness of said over-cladding.

49. The optical device according to claim 40, wherein the thickness of said over-cladding is 7 μm to 10 μm.

50. The optical device according to claim 41, wherein the refractive index of said upper cladding layer is substantially identical to the refractive index of said cap layer.

51. The optical device according to claim 40, wherein the refractive index of said lower cladding is substantially identical to the refractive index of said cap layer.

52. The optical device according to 41, wherein said upper cladding layer comprises silicon oxide.

53. The optical device according to claim 41, wherein said upper cladding layer comprises a silicon oxide-based material doped with fluorine.

54. The optical device according to claim 41, wherein said upper cladding layer comprises a silicon oxide-based material doped with carbon.

55. The optical device according to claim 41, wherein said upper cladding layer comprises a silicon oxide-based material doped with nitrogen.

56. The optical device according to claim 40, wherein said grating trenches are filled with air.

57. The optical device according to claim 40, wherein said core comprises doped silicon-based material.

58. The optical device according to claim 40, wherein the refractive index of said core is 1.448 to 3.5.

59. The optical device according to claim 40, wherein the refractive index of said cladding is 1.446 to 3.5.

60. The optical device according to claim 40, wherein said cap layer has low stress properties.

61. A method for making a waveguide on a substrate, comprising the steps of:
depositing a lower cladding layer on said substrate;
forming at least one core over said lower cladding layer;
depositing a lateral cladding layer over said core and/or over said lower cladding layer, wherein said lateral cladding and said core form a guiding layer;
forming a plurality of empty trenches in said guiding layer; and
depositing in a process chamber a cap layer on top of said plurality of empty trenches using a plasma chemical vapour apparatus, said deposition step comprising the substeps of:
introducing a silicon source into the process chamber; and
selecting the power to form the plasma and the depositing pressure in such a way that the material forming said cap layer is inhibited from filling said trenches.

62. The method according to claim 61, wherein the deposition of said cap layer is a plasma enhanced chemical vapour deposition.

63. The method according to claim 61, comprising the step of introducing a fluorine source in said process chamber during said cap layer deposition step and wherein the step of depositing said cap layer comprises the sub-steps of selecting a power of 80 W to 150 W to form the plasma and selecting a depositing pressure of 900 Mtorr to 1200 Mtorr.

64. The method according to claim 61, wherein said cap layer comprises undoped silicon compound material and the step of depositing said cap layer comprises the sub-steps of selecting a power of 50 W to 100 W to form the plasma and selecting a depositing pressure of 600 Mtorr to 900 Mtorr.

65. The method according to 61, comprising the step of introducing a carbon source and/or a nitrogen source in said process chamber during said cap layer deposition step.

66. The method according to claim 61, wherein the temperature in said process chamber during said cap layer deposition step is 250° C. to 350° C.

67. The method according to claim 61, comprising the step of introducing an oxygen source in said process chamber during said cap layer deposition step.

68. The method according to claim 67, wherein said oxygen source is N₂O.

69. The method according to claim 61, comprising the step of introducing an inert gas in said process chamber during said cap layer deposition step.

70. The method according to claim 61, comprising the step of depositing an upper cladding layer over said cap layer.

71. The method according to claim 61, wherein said silicon source comprises a silane compound.

72. The method according to claim 63, wherein said fluorine source is CF₄.

73. The method according to claim 61, comprising the step of terminating said cap layer deposition process when the thickness of said cap layer is 500 nm to 1500 nm.

74. The method according to claim 73, comprising the step of terminating said cap layer deposition process when the thickness of said cap layer is 700 nm to 1000 nm.

75. The method according to claim 70, comprising the step of terminating the deposition process of said upper cladding layer when the sum of the thickness of said cap layer and of said upper cladding layer is substantially equal to the thickness of said lower cladding layer.

76. The method according to claim 61, comprising the step of selecting said power to form the plasma and said deposition pressure and the temperature of the deposition chamber in such a way that the refractive index of said cap layer is substantially identical to the refractive index of said lateral cladding layer.

77. The method according to claim 61, comprising the step of selecting said power to form plasma in such a way that said cap layer has low stress properties.

78. An optical device containing a waveguide made according to the method of claim 61.
